(19) United States
(12) Patent Application Publication
(10) Pub. No.: US 2024/0087305 A1
(43) Pub. Date: Mar. 14, 2024

(54) INTERACTION METHOD AND APPARATUS, ELECTRONIC DEVICE, AND COMPUTER-READABLE STORAGE MEDIUM

(71) Applicant: BEIJING BYTEDANCE NETWORK TECHNOLOGY CO., LTD., Beijing (CN)

(72) Inventors: Bowen LI, Beijing (CN); Runren LI, Beijing (CN); Jun MA, Beijing (CN); Yuanfu HU, Beijing (CN); Yumin XU, Beijing (CN)

(21) Appl. No.: 18/260,973

(22) PCT Filed: Dec. 6, 2021
(86) PCT No.: PCT/CN2021/135836

§ 371 Date: Jul. 11, 2023

(30) Foreign Application Priority Data
Jan. 13, 2021 (CN) 202110041892.X

(51) Int. Cl. G06V 10/94; G06V 10/74; G06V 10/764

(52) U.S. Cl. CPC G06V 10/945; G06V 10/761; G06V 10/764

(57) ABSTRACT

An interaction method and apparatus, an electronic device, and a computer readable storage medium are provided according to the embodiments of the present disclosure. The interaction method includes: displaying an object recognition component on a first page; jumping from the first page to a second page in response to detecting a trigger signal to the object recognition component; displaying a scan area on the second page to recognize an object in the scan area; displaying, in response to recognizing the object in the scan area, a result display component corresponding to a quantity of the recognized object on the second page; and jumping from the second page to a third page in response to detecting a trigger signal to the result display component, where a content of the third page is related to an object corresponding to the result display component.

The present application is the national phase of International Patent Application No. PCT/CN2021/135836, titled “INTERACTION METHOD AND APPARATUS, ELECTRONIC DEVICE, AND COMPUTER-READABLE STORAGE MEDIUM”, filed on Dec. 6, 2021, which claims priority to Chinese Patent Application No. 202110041892.X, titled “INTERACTION METHOD AND APPARATUS, ELECTRONIC DEVICE, AND COMPUTER-READABLE STORAGE MEDIUM”, filed on Jan. 13, 2021 with the China National Intellectual Property Administration, both of which are incorporated herein by reference in their entireties.

### FIELD

The present disclosure relates to the field of interactions, and in particular to an interaction method and apparatus, an electronic device, and a computer-readable storage medium.

### BACKGROUND

With the rapid development of information technologies, mobile Internet technology is advancing greatly. The emergence of smart devices, the arrival of the 5G era, and also the application of technologies such as big data, AI intelligence and algorithms have facilitated the vigorous development of the electronic mobile devices.

Many platforms currently provide image recognition functions, i.e., recognizing an object taken by a user to provide a product similar to the object and a link to the product. However, the interaction function is weak, and only a single object can be recognized each time, resulting in a single interaction effect, and failing to provide a rich interaction experience to the users.

### SUMMARY

This summary is provided to introduce concepts in a simplified form. These concepts will be described in detail in the following detailed description. This summary is neither intended to recognize key features or essential features of the claimed technical solution, nor intended to limit the scope of the claimed technical solution.

In order to solve the above technical problems, the following technical solutions are provided according to embodiments of the present disclosure.

In a first aspect, an interaction method is provided according to an embodiment of the present disclosure. The method includes:
displaying an object recognition component on a first page;
jumping from the first page to a second page in response to detecting a trigger signal to the object recognition component;
displaying a scan area on the second page to recognize an object in the scan area;
displaying, in response to recognizing the object in the scan area, a result display component corresponding to a quantity of the recognized object on the second page; and
jumping from the second page to a third page in response to detecting a trigger signal to the result display component, where a content of the third page is related to an object corresponding to the result display component.

In a second aspect, an interaction apparatus is provided according to an embodiment of the present disclosure. The apparatus includes: a display module, a jumping module, and a recognition module. The display module is configured to display an object recognition component on a first page. The jumping module is configured to switch from the first page to a second page in response to detecting a trigger signal to the object recognition component. The recognition module is configured to display a scan area on the second page to recognize an object in the scan area. The display module is further configured to display, in response to recognizing the object in the scan area, a result display component corresponding to a quantity of the recognized object on the second page. The jumping module is further configured to jump from the second page to a third page in response to detecting a trigger signal to the result display component, where a content of the third page is related to an object corresponding to the result display component.

In a third aspect, an electronic device is provided according to an embodiment of the present disclosure. The electronic device includes at least one processor, and a memory communicatively connected to the at least one processor. The memory stores instructions executable by the at least one processor. The instructions, when executed by the at least one processor, cause the at least one processor to perform the method in the first aspect.

In a fourth aspect, a non-transitory computer-readable storage medium is provided according to an embodiment of the present disclosure. The non-transitory computer-readable storage medium stores computer instructions that cause a computer to perform the method in the first aspect.

An interaction method and apparatus, an electronic device, and a computer readable storage medium are provided according to the embodiments of the present disclosure. The interaction method includes: displaying an object recognition component on a first page; jumping from the first page to a second page in response to detecting a trigger signal to the object recognition component; displaying a scan area on the second page to recognize an object in the scan area; displaying, in response to recognizing the object in the scan area, a result display component corresponding to a quantity of the recognized object on the second page; and jumping from the second page to a third page in response to detecting a trigger signal to the result display component, where a content of the third page is related to an object corresponding to the result display component. With the above method, the problem of a single interaction effect can be solved by recognizing an object and displaying a result display component corresponding to the quantity of the recognized object.

The above summary is only an overview of the technical solution of the present disclosure In order to better understand the technical means of the present disclosure so that the present disclosure can be implemented according to the contents of the specification, and in order to make the above and other objects, features and advantages of the present disclosure more comprehensible, preferred embodiments will be described in detail below together with the drawings.

### BRIEF DESCRIPTION OF THE DRAWINGS

The above and other features, advantages and aspects of the various embodiments of the present disclosure will become more apparent with reference to the following detailed description in conjunction with the drawings. Throughout the drawings, the same or similar reference numerals denote the same or similar elements. It should be understood that the drawings are schematic and that components and elements are not necessarily drawn to scale.

FIG. 1 is a schematic flowchart of an interaction method according to an embodiment of the present disclosure;

FIG. 2 is a schematic diagram of an application scenario of the interaction method according to an embodiment of the present disclosure.

FIG. 3 is a schematic structural diagram of an interaction apparatus according to an embodiment of the present disclosure; and

FIG. 4 is a schematic structural diagram of an electronic device according to an embodiment of the present disclosure.

### DETAILED DESCRIPTION

Embodiments of the present disclosure will be described in more detail below with reference to the drawings. Although some embodiments of the present disclosure are shown in the drawings, it should be understood that the present disclosure may be embodied in various forms and should not be construed as limited to the embodiments set forth herein. Instead, these embodiments are provided so that the understanding of the present disclosure can be thorough and complete. It should be understood that the drawings and embodiments of the present disclosure are for illustrative purposes only, and are not intended to limit the protection scope of the present disclosure.

It should be understood that the various steps described in the method embodiments of the present disclosure may be performed in different orders, and/or performed in parallel. Additionally, method embodiments may include additional steps and/or illustrated steps may be not performed. The scope of the present disclosure is not limited in this regard.

The term “comprising” and its variations herein are non-exclusive, i.e., “including but not limited to”. The term “based on” means “based at least in part on”. The term “one embodiment” means “at least one embodiment.” The term “another embodiment” means “at least one further embodiment”. The term “some embodiments” means “at least some embodiments.” Relevant definitions of other terms will be given in the description below.

It should be noted that concepts such as “first” and “second” mentioned herein are only for distinguishing different devices, modules or units, rather than limiting the sequence or interdependence of functions performed by these devices, modules or units.

It should be noted that the determiners of “a” and “a plurality” mentioned in the present disclosure are illustrative but not restrictive. Those skilled in the art should understand that, unless the context clearly indicates otherwise, such determiners should be understood as “one or more”.

The names of messages or information exchanged between multiple devices in the embodiments of the present disclosure are used for illustrative purposes only, and are not used to limit the scope of these messages or information.

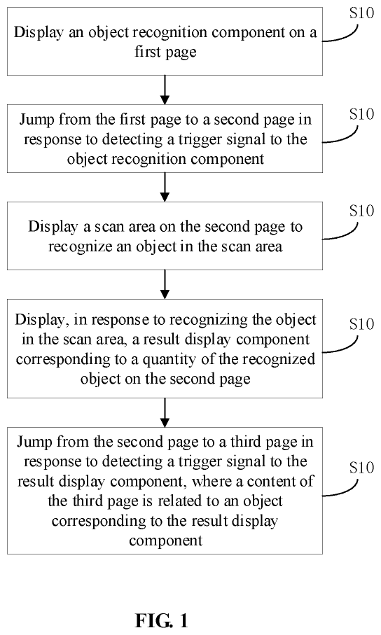

FIG. 1 is a flowchart of an interaction method according to an embodiment of the present disclosure. The interaction method according to the embodiment may be performed by an interaction apparatus. The interaction apparatus may be implemented as software, or as a combination of software and hardware. The interaction apparatus may be integrated in an apparatus, e.g., an interaction server or an interaction terminal device, in an interaction system. As shown in FIG. 1, the method includes the following steps S101 to S105.

In step S101, an object recognition component is displayed on a first page.

Preferably, the first page is a content display page in an application on a cell phone and includes content to be displayed to a user and some functional options or components related to the content.

For example, the content display page may be a home page interface in an application on a cell phone, an information page of the user, etc.

Preferably, the first page may further include an information display area for displaying text, images, videos, etc. Preferably, the first page may further include various functional components, such as a search bar, a live streaming portal, a jump link to another page, a sub-column option. The object recognition component may be a portal for an object recognition function for enabling an object recognition function, where the object may include any object, such as a car, a cell phone, a TV.

Preferably, the object recognition component may be a sub-component of another component, e.g. the object recognition component may be a sub-component of a search bar.

In step S102, in response to detecting a trigger signal to the object recognition component, it is jumped from the first page to a second page.

The trigger signal to the object recognition component may include, but is not limited to: a human-computer interaction signal received through a human-computer interaction interface, such as a click signal generated by clicking the object recognition component on a touch screen; a voice command of a user received through a microphone to enable the object recognition component; a specific pose or gesture of a user recognized through a camera, etc. The form of the trigger signal is not limited in the present disclosure and will not be repeated here.

In a case that a trigger signal to the object recognition component is detected, the page displayed by the application is controlled to jump from the first page to a second page, where the second page may also include content to be displayed to the user, functional components related to the object recognition function, components related to the page, etc. For example, an image captured by a camera of a cell phone is displayed on the second page and a flash on button, a photo selection button, a button for returning to the first page and the like that are used for object recognition are also displayed on the second page.

In step S103, a scan area is displayed on the second page to recognize an object in the scan area.

The scan area is displayed on the second page, the scan area is used to determine a range of an object to be recognized. For example, the scan area may be all or part of an area that is captured by a camera of a cell phone.

The image in the scan area is collected and inputted into a recognition program to recognize the object in the scan area.

Preferably, the step S103 includes: displaying a scan line moving cyclically from a start position to an end position, where the scan area is an area between the start position and end position; and stopping displaying the scan line in a case that a focusable object and an outer frame of the object are displayed in the scan area.

In the embodiment, the scan area is determined dynamically by the scan line, where the scan area is formed by moving the scan line from the start position to the end position. For example, if the scan line moves from the top to the bottom of the screen, the length of the scan line is using as a length and a distance that the scan line moves is used as a width, a rectangle thus formed is the scan area. For example, the scan line has an end point as a center of a circle and rotates around the center, in this case the start position and the end position are the same, and a circle thus formed by moving the scan line is the scan area. It is to be understood that the start position and the end position may be any positions in the screen, and the scan line may be moved in any way, and the scan line moves in a circular manner to prompt the user of the range of the scan area.

In a case that a focusable object is displayed in the scan area and the outer frame of the object is recognized, the scan line is not displayed. In this case, as the position of the object is recognized, the type of object, etc., may be further recognized. If the object is a car, the car in the scan area is first recognized in this step, and an outer frame is added to each recognized car in the scan area and the scan line is not displayed.

After displaying the outer frame of the object, the type of the object is further recognized. For example, after the car is recognized, the series of the car, etc. is recognized. Preferably, after the step S202, the method further includes:
displaying a first dynamic identifier in the outer frame of the object, where the first dynamic identifier indicates that the object in the outer frame is being recognized.

For example, a dynamic loading icon is displayed in the outer frame of the object to indicate that the object in the outer frame is being recognized. In this case, the above interaction process may be implemented by using two recognition models. Firstly, an object positioning model may be used to perform regression to determine the position of the object in the scan area, where the positioning result is indicated by the outer frame of the object. Then, a first dynamic identifier may be displayed in the outer frame of the object, an image of the object in the outer frame may be inputted into an object classification model to obtain a specific type of the object to complete the object recognition.

The above interaction process may also be implemented by using an object recognition model. In this case, the object recognition model outputs both the outer frame and the specific type of the object, but displays the outer frame first and the first dynamic identifier afterwards to provide a rich interaction effect to the user.

In step S104, in response to recognizing the object in the scan area, a result display component corresponding to a quantity of the recognized object is displayed on the second page.

Preferably, the recognizing an object in the scan area may include: displaying, in the scan area, an anchor point and a name of the recognized object. The anchor point is used to identify a position of the recognized object on the second page, and the name of the object is displayed around the anchor point. The name of the object is used to indicate a type of the object. For example, if the object is a car, the name of the object includes the name of the series of the car.

Preferably, the result display component may include an information display area. The information display area is used to display information of an object corresponding to the result display component. If the object is a car, the result display component includes an information display area for displaying information of most cars, such as the name of the series, prices, performance parameters, highlights.

Preferably, the displaying a result display component corresponding to the quantity of recognized object on the second page includes:
displaying the result display component at a predetermined position on the second page, where a quantity of result display component is the same as the quantity of the recognized object. A result display component corresponding to a first object is displayed at a middle part of the predetermined position, where the first object meets a predetermined condition.

The predetermined position on the second page includes a position outside the scan area or a position within the scan area. The result display component has a predetermined shape, such as a rectangle, a circle, a triangle or any other customized shape. For example, if the result display component is a rectangle card component, and the quantity of the result display component is the same as the quantity of the recognized object, and if 3 objects are recognized in the scan area, 3 result display cards corresponding to the 3 objects are displayed at the predetermined position.

Since there may be multiple result display components, the multiple result display components should be displayed according to a specific order. Therefore, the result display component corresponding to the first object is displayed in the middle part of the predetermined position, where the first object is one of the recognized object and the first object meets a predetermined condition. The predetermined condition may indicate, but is not limited to that: the first object occupies the largest area in the scan area, the first object is located at the bottom of the scan area, the first object is located at the top of the scan area or the first object is the object selected by the user.

Preferably, the displaying a result display component corresponding to a quantity of recognized object on the second page includes:
displaying, in the result display component, information of an object with a maximum similarity to the object in the scan area; and
switching, in response to receiving an information switching signal to the result display component, information of the object displayed in the result display component to information of another similar object.

There may be multiple object recognition results, for example, the object may be recognized as multiple types, and each type corresponds to a similarity, in this case, the information of the object with the maximum similarity is displayed in the result display component by default. If the object is a car 1, the recognition result includes multiple car series, such as car series A, car series B and car series C, similarities of which to the car in the scan area are 97%, 95% and 90% respectively, in this case, the information of the car series A is displayed in the result display component corresponding to the car 1.

When an information switching signal to the result display component is received, the information being displayed in the result display component is switched to information of other similar objects. As in the above example, when a slide up or slide down action is detected at the position corresponding to the result display component, information of the car series B or car series C is displayed; or when a double-click action is detected in the area corresponding to the car 1, information of the car series B or car series C is displayed. In this way, for the same object, information of multiple objects similar to the object can be displayed, and the user may select corresponding information to display according to actual situations.

Further, the method further includes:
hiding or partially displaying the result display component if the quantity of the result display component is greater than the maximum display quantity of the second page; and
displaying or completely displaying the hidden or partially displayed result display component in response to receiving a switching signal to the result display component.

In the above step, when the quantity of the result display components is greater than the quantity that can be displayed on the second page, for example, where only two result display components can be displayed at a preset position, if the quantity of result display components is more than two, the extra result display component cannot be displayed on the second page. In this case, the result display components are hidden or partially displayed. For example, the result display component corresponding to the first object is displayed in the middle part of the predetermined position, and the result display components corresponding to other objects are partially displayed on both sides of the middle part.

Afterwards, when receiving a switch signal to the result display component, it is switched to the result display component of another object. For example, if a signal of sliding to the left or sliding to the right is detected at the predetermined position, the result display components partially displayed or hidden on the left or right is switched to the middle part of the predetermined position; or if a signal of clicking on the object recognized in the scan area is received, the result display component corresponding to the selected object is switched to the middle part of the predetermined position.

Further, the interaction method further includes:
displaying first prompt information in the scan area until the result display component is displayed on the second page.

When scanning an object in the scan area and recognizing the object, the first prompt information is displayed in the scan area to prompt the user to correctly operate a terminal such as a cell phone to ensure that the object can be quickly and correctly recognized. Further, when there are multiple pieces of first prompt information, the first prompt information is cyclically switched according to a predetermined time interval. If there are two pieces of prompt information, the first prompt information is displayed at a predetermined position of the first prompt information in the scan area, after which the second first prompt information is displayed after a time interval of 3 seconds until the result display component is displayed, which indicates that the object has been successfully recognized, at which time the first prompt information is stopped being displayed.

It is to be understood that the above recognized object may be the same type or different types. For example, the recognized 3 objects may be all cars, or the recognized 3 objects may be a car, a motorcycle and a bicycle respectively.

In step S105, in response to detecting a trigger signal to the result display component, it is jumped from the second page to a third page, where the content of the third page is related to an object corresponding to the result display component.

In the present disclosure, in addition to displaying information of the object, the result display component may be a jump portal for another information display page or a function page. The trigger signal to the result display component includes a human-computer interaction signal received through a human-computer interface of a terminal, such as a click signal received through a touch screen, a selection command signal entered through a mouse, a keyboard, etc. In an embodiment, the result display component is a result display card, if a click signal is detected at any position on the result display card, the page displayed by the mobile application may jump from the second page to a third page to display the content related to the object.

Preferably, the third page includes information related to the object and/or a jump portal for information related to the object. If the third page is a detail page of the object, which displays details of the object, the third page may also include a jump portal for other information related to the object. If the object is a car, the third page is a detail page of the car, which includes a jump portal for a functions page, a ratings page, etc.

In the above embodiment, with the interaction method, an object recognition component is displayed on the first page, and a scan area is displayed on the second page, and in a case that the object is recognized, a result display component corresponding to the quantity of the recognized object is displayed, and the result display component allows jumping to the third page related to the object. Therefore, the problem of the single interaction effect and the cumbersome operation for recognizing multiple objects in the existing platform is solved.

Further, a re-recognition component may be provided on the second page to re-recognize the object in the scan area in response to detecting a trigger signal to the re-recognition component. For example, the re-recognizing component is a button, and when the button is clicked by a user, the steps S102 to S103 are repeated to re-recognize the object and display the result display component corresponding to the object.

Further, the interaction method further includes:

displaying second prompt information on the second page in response to no object being recognized in the scan area within a predetermined time period.

The above step may be applied to a case that there is no object in the scan area or the object is not correctly recognized, in this case, the second prompt information may be displayed on the second page to prompt the user that there is no object recognized in the current scan area, or to prompt the user to align the scan area with the object to be recognized, etc.

The above step may also be applied to a case that the network of a terminal device is abnormal, in some implementations, the recognition model is an offline model, if the network of the user is poor, the result display card cannot be displayed. In this case, the second prompt information may prompt the user that the network status is abnormal, and the user should click the retry button if the user wants to recognize the image continually. When the user clicks the retry button, the image in the scan area is saved for re-recognition.

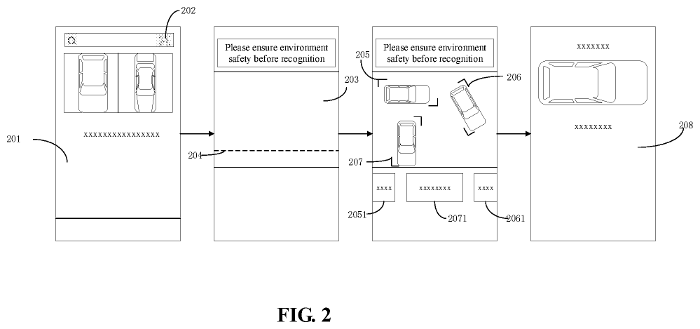

FIG. 2 is a schematic diagram of an application scenario according to an embodiment of the present disclosure. As shown in FIG. 2, in this application scenario, a car-related application is running in the terminal device, and when the user opens the application, information of various cars is displayed on the first page 201, and a car recognition button 202 is displayed in a search bar. When the user clicks the car recognition button 202, the application jumps from the first page 201 to a second page, which includes a scan area 203 and a scan line 204 in the scan area. The user may align the scan area 203 to a car to be recognized in order to recognize the specific series of the car. When the series of the car is recognized, the scan line 204 is stopped being displayed, the outer frames 205, 206 and 207 of the recognized cars are displayed in the scan area 203, and the recognition result display cards 2051, 2061 and 2071 of the cars are displayed on the second page. The recognition result display cards are arranged horizontally, the user may select the recognition result display card by an operation of sliding to the left or to the right. When the user clicks on one of the recognition result display cards, the application jumps from the second page to the third page 208 to display details of a car corresponding to the recognition result display card.

An interaction method is provided according to the embodiments, which includes: displaying an object recognition component on a first page; jumping from the first page to a second page in response to detecting a trigger signal to the object recognition component; displaying a scan area on the second page to recognize an object in the scan area; and displaying, in response to recognizing the object in the scan area, a result display component corresponding to the quantity of the recognized object on the second page; jumping from the second page to a third page in response to detecting a trigger signal to the result display component, where content of the third page is related to an object corresponding to the result display component. With the above method, the problem of a single interaction effect can be solved by recognizing an object and displaying a result display component corresponding to the quantity of the recognized object.

In the above, although the steps in the above method embodiments are described in the above order, it should be clear to those skilled in the art that the steps in the embodiments of the present disclosure are not necessarily performed in the above order. Alternatively, the steps may be performed in reverse, parallel, interleaved, or other sequences. Moreover, on the basis of the above steps, those skilled in the art may also add other steps. These apparent modifications or equivalent replacements should also be included in the protection scope of the present disclosure, and are not described in detail herein.

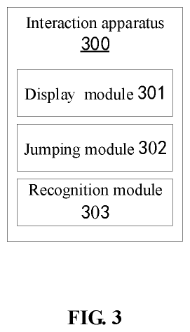

FIG. 3 is a schematic structural diagram of an interaction apparatus according to an embodiment of the present disclosure. As shown in FIG. 3, the apparatus 300 includes: a display module 301, a jumping module 302, and a recognition module 303. The display module 301 is configured to display an object recognition component on a first page. The jumping module 302 is configured to jump from the first page to a second page in response to detecting a trigger signal to the object recognition component. The recognition module 303 is configured to display a scan area on the second page to recognize an object in the scan area. The display module 301 is further configured to display, in response to recognizing the object in the scan area, a result display component corresponding to a quantity of the recognized object on the second page. The jumping module 302 is further configured to jump from the second page to a third page in response to detecting a trigger signal to the result display component, where content of the third page is related to an object corresponding to the result display component.

Further, the recognition module 303 is further configured to: display a scan line moving cyclically from a start position to an end position, where the scan area is an area between the start position and end position; and stopping displaying the scan line in a case that a focusable object and an outer frame of the object are displayed in the scan area.

Further, the recognition module 303 is further configured to: display a first dynamic identifier in the outer frame of the object, the first dynamic identifier is used to indicate that an object in the outer frame is being recognized.

Further, the display module 301 is further configured to: display, in the scan area, an anchor point and the name of the recognized object.

Further, the display module 301 is further configured to: display a result display component at a predetermined position on the second page, where the quantity of result display component is the same as the quantity of the recognized object, and a result display component corresponding to a first object is displayed at a middle part of the predetermined position, where the first object meets a predetermined condition.

Further, the display module 301 is further configured to: hide or partially display the result display component in a case that the quantity of the result display components is greater than the maximum display quantity of the second page; display or completely display the hidden or partially displayed result display component in response to receiving a trigger signal to the result display component.

Further, the result display component includes an information display area, the information display area is configured to display information of the object corresponding to the result display component.

Further, the third page includes information related to the object and/or a jump portal of information related to the object.

Further, the recognition module 303 is further configured to: display a prompt information in the scan area until the result display component is displayed on the second page.

Further, the display module 301 is further configured to: display, in the result display component, information of an object with the maximum similarity to the object in the scan area; and switch, in response to receiving an information switching signal to the result display component, the information of the object displayed in the result display component to information of another similar object.

The apparatus shown in FIG. 3 may perform the method in the embodiment shown in FIG. 1. For the parts not described in detail in this embodiment, reference may be made to the relevant description of the embodiment shown in FIG. 1. Details about the process and technical effects of this technical solution may refer to the description in the embodiment shown in FIG. 1, which are not repeated here.

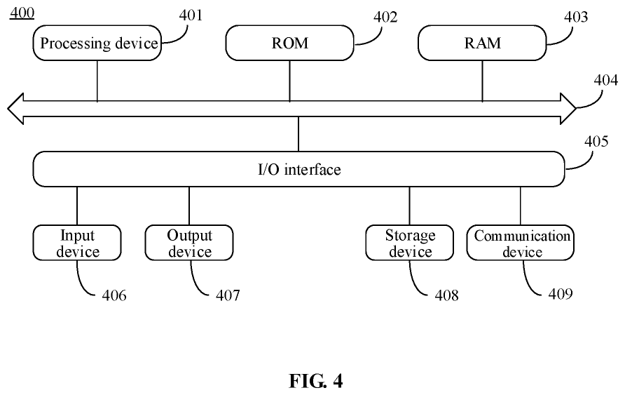

Reference is made to FIG. 4, which is a schematic structural diagram of an electronic device 400 suitable for implementing the embodiments of the present disclosure. The terminal device in the embodiments of the present disclosure may include but not limited to mobile terminals such as mobile phones, notebook computers, digital broadcast receivers, PDAs (personal digital assistants), PADs (tablet computers), PMPs (portable multimedia players) and vehicle terminals (such as car navigation terminals); and fixed terminals such as digital TVs and desktop computers. The electronic device shown in FIG. 4 is only an example, and should not limit the functions and application scope of the embodiments of the present disclosure.

As shown in FIG. 4, the electronic device 400 may include a processing device (such as a central processing unit and a graphics processing unit) 401. The processing device 401 can execute various appropriate actions and processes according to programs stored in a read only memory (ROM) 402 or loaded from a storage device 408 into a random-access memory (RAM) 403. In the RAM 403, various programs and data necessary for the operation of the electronic device 400 are also stored. The processing device 401, the ROM 402 and the RAM 403 are connected to each other through a bus 404. An input/output (I/O) interface 405 is also connected to the bus 404.

Generally, the following devices may be connected to the I/O interface 405: input devices 406 including, for example, a touch screen, a touch pad, a keyboard, a mouse, a camera, a microphone, an accelerometer, a gyroscope, etc.; output devices 407 including, for example, a liquid crystal display (LCD), a speaker, a vibrator, etc.; a storage device 408 including, for example, a magnetic tape, a hard disk, etc.; and a communication device 409. The communication device 409 may allow the electronic device 400 to perform wireless or wired communication with other devices to exchange data. Although FIG. 4 shows the electronic device 400 having various means, it should be understood that implementing or having all of the devices shown is not a requirement. More or fewer devices may alternatively be implemented or provided.

In particular, according to an embodiment of the present disclosure, the processes described above with reference to the flowcharts may be implemented as computer software programs. For example, a computer program product is provided according to an embodiment of the present disclosure. The computer program product includes a computer program carried on a non-transitory computer-readable medium. The computer program contains program code for carrying out the methods shown in the flowcharts. In such an embodiment, the computer program may be downloaded and installed from a network via the communication device 409, or from the storage device 408, or from the ROM 402. When the computer program is executed by the processing device 401, the functions defined in the methods of the embodiments of the present disclosure are performed.

It should be noted that the above computer-readable medium in the present disclosure may be a computer-readable signal medium or a computer-readable storage medium or any combination of the above two. The computer readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to: electrical connections with one or more wires, portable computer disks, hard disks, a random-access memory (RAM), a read only memory (ROM), an erasable programmable read-only memory (EPROM or Flash), optical fibers, a compact disk read-only memory (CD-ROM), optical storage devices, magnetic memory components, or any suitable combination of the above. In the present disclosure, the computer-readable storage medium may be any tangible medium that contains or stores a program. The program may be used by or in conjunction with the instruction execution system, apparatus or device. In the present disclosure, however, the computer-readable signal medium may include a data signal propagated in baseband or as part of a carrier wave, and the data signal carries computer-readable program code. Such propagated data signals may be in various forms, including but not limited to electromagnetic signals, optical signals, or any suitable combination of the foregoing. The computer-readable signal medium may also be any computer-readable medium other than the computer-readable storage medium. The computer-readable signal medium may transmit, propagate, or transport a program for use by or in connection with an instruction execution system, apparatus, or device. Program code embodied on the computer-readable medium may be transmitted by any appropriate medium, including but not limited to: wires, optical cables, RF (radio frequency), etc., or any suitable combination of the above.

In some embodiments, a client may communicate with a server using any currently known or future-developed network protocols such as HTTP (Hypertext Transfer Protocol), and the client and the server may be interconnected with digital data communication of any form or medium (e.g., a communication network). Examples of the communication network include local area networks (“LANs”), wide area networks (“WANs”), internetworks (e.g., the Internet), peer-to-peer networks (e.g., ad hoc peer-to-peer networks), as well as any currently known or future developed network.

The computer-readable medium may be included in the electronic device, or may exist independently without being incorporated into the electronic device.

The computer-readable medium carries one or more programs, when being executed by the electronic device, causes the electronic device to perform the interaction method in the above embodiments.

The computer program code for carrying out operations of the present disclosure may be written in one or more programming languages, or a combination thereof. Such programming languages include, but are not limited to, object-oriented programming languages such as Java, Smalltalk, C++, and conventional procedural programming languages such as the “C” language or similar programming languages. The program code may be executed entirely on the user computer, partly on the user computer, as a stand-alone software package, partly on the user computer and partly on a remote computer or entirely on a remote computer or server. Where a remote computer is involved, the remote computer may be connected to the user computer through any kind of network including a local area network (LAN) or a wide area network (WAN), or may be connected to an external computer (e.g., via the Internet by an Internet service provider).

The flowcharts and block diagrams in the drawings illustrate the architecture, functionality, and operation of possible implementations of systems, methods and computer program products according to various embodiments of the present disclosure. In this regard, each block in the flowchart or block diagram may represent a module, program segment, or portion of code. The module, program segment, or portion of code contains one or more executable instructions for implementing specified logical functions. It should also be noted that, in some alternative implementations, the functions noted in the block may occur in an order different form the order noted in the drawings. For example, two blocks shown in succession could, in fact, be executed substantially concurrently or in reverse order, depending upon the functionality involved. Further, each block in the block diagrams and/or flow charts, and a combination of blocks in the block diagrams and/or flow diagrams may be performed by a dedicated hardware-based system that performs the specified functions or operations or by a combination of dedicated hardware and computer instructions.

The units involved in the embodiments described in the present disclosure may be implemented by software or by hardware. The name of a unit does not in any way constitute a qualification of the unit itself.

The functions described herein may be performed at least in part by one or more hardware logic components. For example, without limitation, exemplary types of hardware logic components that may be used include: field programmable gate arrays (FPGAs), application specific integrated circuits (ASICs), application specific standard products (ASSPs), system on chips (SOCs), complex programmable logical devices (CPLDs), etc.

In the context of the present disclosure, the machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of the machine-readable storage medium may include one or more wire-based electrical connections, portable computer disks, hard disks, a random-access memory (RAM), a read only memory (ROM), an erasable programmable read only memory (EPROM or flash memory), fiber optics, a compact disk read-only memory (CD-ROM), optical storage devices, magnetic storage devices, or any suitable combination of the foregoing.

According to one or more embodiments of the present disclosure, an interaction method is provided, which includes:
displaying an object recognition component on a first page;
jumping from the first page to a second page in response to detecting a trigger signal to the object recognition component;
displaying a scan area on the second page to recognize an object in the scan area;
displaying, in response to recognizing the object in the scan area, a result display component corresponding to a quantity of the recognized object on the second page; and
jumping from the second page to a third page in response to detecting a trigger signal to the result display component, where a content of the third page is related to an object corresponding to the result display component.

Further, the displaying a scan area on the second page to recognize an object in the scan area includes:

displaying a scan line moving cyclically from a start position to an end position, where the scan area is an area between the start position and the end position; and
stopping displaying the scan line in a case that a focusable object and an outer frame of the object are displayed in the scan area.

Further, the method further includes:
displaying a first dynamic identifier in the outer frame of the object, where the first dynamic identifier indicates that the object in the outer frame is being recognized.

Further, the recognizing the object in the scan area includes:
displaying, in the scan area, an anchor point and a name of the recognized object.

Further, the displaying a result display component corresponding to a quantity of the recognized object on the second page includes:
displaying the result display component at a predetermined position on the second page, where a quantity of the result display component is the same as the quantity of the recognized object, and where
a result display component corresponding to a first object is displayed at a middle part of the predetermined position, and the first object meets a predetermined condition.

Further, the method further includes:
hiding or partially displaying the result display component if the quantity of the result display component is greater than a maximum display quantity of the second page; and
displaying or completely displaying the hidden or partially displayed result display component in response to receiving a switch signal to the result display component.

Further, the result display component includes an information display area, and the information display area is configured to display information of an object corresponding to the result display component.

Further, the third page includes information related to the object and/or a jump portal for the information related to the object.

Further, the method further includes:
displaying prompt information in the scan area until the result display component is displayed on the second page.

Further, the displaying a result display component corresponding to the quantity of the recognized object on the second page includes:
displaying, in the result display component, information of an object with a maximum similarity to the object in the scan area; and
switching, in response to receiving an information switching signal to the result display component, information of the object displayed in the result display component to information of another similar object.

According to one or more embodiments of the present disclosure, an interaction apparatus is provided, which includes: a display module, a jumping module, and a recognition module. The display module is configured to display an object recognition component on a first page. The jumping module is configured to jump from the first page to a second page in response to detecting a trigger signal to the object recognition component. The recognition module is configured to display a scan area on the second page to recognize an object in the scan area. The display module is further configured to display, in response to recognizing the object in the scan area, a result display component corresponding to a quantity of the recognized object on the second page. The jumping module is further configured to jump from the second page to a third page in response to detecting a trigger signal to the result display component, where content of the third page is related to an object corresponding to the result display component.

Further, the recognition module is further configured to: display a scan line moving cyclically from a start position to an end position, where the scan area is area between the start position and end position; and stop displaying the scan line in a case that a focusable object and an outer frame of the object are displayed in the scan area.

Further, the recognition module is further configured to: display a first dynamic identifier in the outer frame of the object, the first dynamic identifier indicates that the object in the outer frame is being recognized.

Further, the display module is further configured to: display, in the scan area, an anchor point and the name of the recognized object.

Further, the display module is further configured to: display a result display component at a predetermined position on the second page, where the quantity of result display component is the same as the quantity of the recognized object, and a result display component corresponding to a first object is displayed at a middle part of the predetermined position, where the first object meets a predetermined condition.

Further, the display module is further configured to: hide or partially display the result display component in a case that the quantity of the result display components is greater than the maximum display quantity of the second page; display or completely display the hidden or partially displayed result display component in response to receiving a trigger signal to the result display component.

Further, the result display component includes an information display area, the information display area is configured to display information of the object corresponding to the result display component.

Further, the third page includes information related to the object and/or a jump portal of information related to the object.

Further, the recognition module is further configured to: display a prompt information in the scan area until the result display component is displayed on the second page.

Further, the display module is further configured to: display, in the result display component, information of an object with the maximum similarity to the object in the scan area; and switch, in response to receiving an information switching signal to the result display component, the information of the object displayed in the result display component to information of another similar object.

According to one or more embodiments of the present disclosure, an electronic device is provided. The electronic device includes at least one processor, and a memory communicatively connected to the at least one processor. The memory stores instructions executable by the at least one processor. The instructions, when executed by the at least one processor, cause the at least one processor to perform the interaction method in the first aspect.

According to one or more embodiments of the present disclosure, a non-transitory computer-readable storage medium. The non-transitory computer-readable storage medium stores computer instructions that cause a computer to perform the interaction method in the first aspect.

Only preferred embodiments of the present disclosure and an illustration of the applied technical principle are described above. Those skilled in the art should understand that, the scope of the present disclosure is not limited to the technical solution formed by specific combinations of the above technical features, but also covers other technical solutions formed by any combination of the above technical features or their equivalent features without departing from the above disclosed concept, for example, a technical solution formed by replacing the above features with technical features with similar functions disclosed in (but not limited to) the present disclosure.

1. An interaction method, comprising:
displaying an object recognition component on a first page;
jumping from the first page to a second page in response to detecting a trigger signal to the object recognition component;
displaying a scan area on the second page to recognize an object in the scan area;
displaying, in response to recognizing the object in the scan area, a result display component corresponding to a quantity of the recognized object on the second page; and
jumping from the second page to a third page in response to detecting a trigger signal to the result display component, wherein a content of the third page is related to an object corresponding to the result display component.

2. The interaction method according to claim 1, wherein the displaying a scan area on the second page to recognize an object in the scan area comprises:
displaying a scan line moving cyclically from a start position to an end position, wherein the scan area is an area between the start position and the end position; and
stopping displaying the scan line in a case that a focusable object and an outer frame of the object are displayed in the scan area.

3. The interaction method according to claim 2, further comprising:
displaying a first dynamic identifier in the outer frame of the object, wherein the first dynamic identifier indicates that the object in the outer frame is being recognized.

4. The interaction method according to claim 1, wherein the recognizing the object in the scan area comprises:
displaying, in the scan area, an anchor point and a name of the recognized object.

5. The interaction method according to claim 1, wherein the displaying a result display component corresponding to a quantity of the recognized object on the second page comprises:
displaying the result display component at a predetermined position on the second page, wherein a quantity of the result display component is the same as the quantity of the recognized object, and wherein
a result display component corresponding to a first object is displayed at a middle part of the predetermined position, and the first object meets a predetermined condition.

6. The interaction method according to claim 1, further comprising:
hiding or partially displaying the result display component if the quantity of the result display component is greater than a maximum display quantity of the second page; and
displaying or completely displaying the hidden or partially displayed result display component in response to receiving a switch signal to the result display component.

7. The interaction method according to claim 1, wherein the result display component comprises an information display area, and the information display area is configured to display information of the object corresponding to the result display component.

8. The interaction method according to claim 1, wherein the third page comprises information related to the object and/or a jump portal for the information related to the object.

9. The interaction method according to claim 1, further comprising:
displaying prompt information in the scan area until the result display component is displayed on the second page.

10. The interaction method according to claim 1, wherein the displaying a result display component corresponding to a quantity of the recognized object on the second page comprises:
displaying, in the result display component, information of an object with a maximum similarity to the object in the scan area; and
switching, in response to receiving an information switching signal to the result display component, information of the object displayed in the result display component to information of another similar object.

11. An interaction apparatus, comprising:
at least one processor; and
at least one memory communicatively coupled to the at least one processor and storing instructions that upon execution by the at least one processor cause the apparatus to:
display an object recognition component on a first page;
jump from the first page to a second page in response to detecting a trigger signal to the object recognition component; and
display a scan area on the second page to recognize an object in the scan area, wherein
display, in response to recognizing the object in the scanning area, a result display component corresponding to a quantity of the recognized object on the second page, and
jump from the second page to a third page in response to detecting a trigger signal to the result display component, wherein a content of the third page is related to an object corresponding to the result display component.

12. (canceled)

13. A non-transitory computer-readable storage medium, bearing computer-readable instructions that upon execution on a computing device cause the computing device at least to:
display an object recognition component on a first page;
jump from the first page to a second page in response to detecting a trigger signal to the object recognition component; and
display a scan area on the second page to recognize an object in the scan area, wherein
display, in response to recognizing the object in the scanning area, a result display component corresponding to a quantity of the recognized object on the second page, and jump from the second page to a third page in response to detecting a trigger signal to the result display component, wherein a content of the third page is related to an object corresponding to the result display component.

14. The interaction method according to claim 5, further comprising:
hiding or partially displaying the result display component if the quantity of the result display component is greater than a maximum display quantity of the second page; and
displaying or completely displaying the hidden or partially displayed result display component in response to receiving a switch signal to the result display component.

15. The apparatus of claim 11, the at least one memory further storing instructions that upon execution by the at least one processor cause the apparatus to:
display a scan line moving cyclically from a start position to an end position, wherein the scan area is an area between the start position and the end position; and
stop display the scan line in a case that a focusable object and an outer frame of the object are displayed in the scan area.

16. The apparatus of claim 11, the at least one memory further storing instructions that upon execution by the at least one processor cause the apparatus to:
display a first dynamic identifier in the outer frame of the object,
wherein the first dynamic identifier indicates that the object in the outer frame is being recognized.

17. The apparatus of claim 11, the at least one memory further storing instructions that upon execution by the at least one processor cause the apparatus to:
display, in the scan area, an anchor point and a name of the recognized object.

18. The apparatus of claim 11, the at least one memory further storing instructions that upon execution by the at least one processor cause the apparatus to:
display the result display component at a predetermined position on the second page, wherein a quantity of the result display component is the same as the quantity of the recognized object, and
wherein a result display component corresponding to a first object is displayed at a middle part of the predetermined position, and the first object meets a predetermined condition.

19. The apparatus of claim 11, the at least one memory further storing instructions that upon execution by the at least one processor cause the apparatus to:
hide or partially display the result display component if the quantity of the result display component is greater than a maximum display quantity of the second page; and
display or completely display the hidden or partially displayed result display component in response to receiving a switch signal to the result display component.

20. The apparatus of claim 18, the at least one memory further storing instructions that upon execution by the at least one processor cause the apparatus to:
hide or partially display the result display component if the quantity of the result display component is greater than a maximum display quantity of the second page; and
display or completely display the hidden or partially displayed result display component in response to receiving a switch signal to the result display component.
